(19) United States
(12) Patent Application Publication
(10) Pub. No.: US 2024/0272395 A1
(43) Pub. Date: Aug. 15, 2024

(54) A COMBINED FACEPLATE FOR ACCOMMODATING OPTICAL TRANSCEIVER MODULES

(71) Applicant: Infinera Corp., San Jose, CA (US)

(72) Inventor: Zhen Lei, Shanghai (CN)

(21) Appl. No.: 18/439,303

(22) Filed: Feb. 12, 2024

Related U.S. Application Data
(60) Provisional application No. 63/444,676, filed on Feb. 10, 2023.

(51) Int. Cl. G02B 6/44

(52) U.S. Cl. CPC G02B 6/44528; G02B 6/44524

(57) ABSTRACT

Assemblies and methods of use are described herein, including a telecommunication tray assembly, comprising a base structure, a faceplate assembly, and first and second ports. The base structure has front and rear ends and a length. The faceplate assembly is attached to the base structure and defines a first opening configured to receive a first type of optical module and a second opening configured to receive a second type of optical module. The first port is supported by the base structure, aligned with the first opening, and configured to receive the first type of optical module, and has a first leading edge offset from the front end by a first distance. The second port is supported by the base structure, aligned with the second opening, and configured to receive the second type of optical module and has a second leading edge offset from the front end by a second distance.

### CROSS-REFERENCE TO RELATED APPLICATIONS

This application claims priority to the provisional patent application identified by U.S. Ser. No. 63/444,676, filed Feb. 10, 2023, the entire content of which is hereby expressly incorporated herein by reference.

### BACKGROUND ART

Telecommunication trays often serve as crucial components in network infrastructure, facilitating the organization and management of optical modules essential for data transmission. One common challenge encountered in these systems pertains to the integration of multiple optical modules, each with distinct dimensions, into a single faceplate assembly of a telecommunication tray assembly.

In telecommunication infrastructure, the demand for versatility and scalability is paramount, driving the need to accommodate various optical modules of differing sizes and configurations within the same telecommunication tray assembly. This necessity arises from the diverse requirements of network architectures, where different types of optical modules are utilized for specific functionalities, such as data transmission, reception, or signal processing.

The integration of different types of optical modules with different dimensions into a single faceplate assembly presents several technical hurdles. Primarily, it requires the development of a unified interface mechanism capable of accommodating disparate module sizes while ensuring precise alignment and secure attachment. Furthermore, the design must address issues related to space constraints, thermal management, and overall system integrity.

Traditional methods of incorporating different types of optical modules into faceplates often involve face plate assemblies having planar ports which cause differences in the lengths of the different types of optical modules to result in misalignment of the distal ends of the optical modules, limiting the space available to route cables attached to the optical modules in a space-constrained environment. As a result, telecommunication trays may face inefficiencies, increased costs, and compatibility issues when integrating modules with non-standard sizes or configurations.

The complexity of the problem intensifies when considering the optical performance and signal integrity requirements of the integrated optical modules. Ensuring optimal optical alignment, minimal signal loss, and reliable connectivity across all optical modules assists in maintaining the overall performance and reliability of the telecommunication system.

It is to such an improved faceplate assembly of a telecommunication tray assembly that the presently disclosed invention is directed.

### SUMMARY OF THE INVENTION

A method and system are disclosed. In one implementation, the present disclosure includes a telecommunication tray assembly, comprising: a base structure having a front end, a rear end opposite the front end, and a length extending from the front end to the rear end; a faceplate assembly attached to the front end of the base structure, the faceplate assembly defining a first opening configured to receive a first type of optical module and a second opening configured to receive a second type of optical module; a first port supported by the base structure and aligned with the first opening, the first port configured to receive the first type of optical module and having a first leading edge offset from the front end by a first distance; and a second port supported by the base structure and aligned with the second opening, the second port configured to receive the second type of optical module and having a second leading edge offset from the front end by a second distance larger than the first distance.

### BRIEF DESCRIPTION OF THE DRAWINGS

The accompanying drawings, which are incorporated in and constitute a part of this specification, illustrate one or more embodiment described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a front perspective view of an exemplary embodiment of a telecommunication equipment chassis constructed in accordance with the present disclosure.

FIG. 2 is a rear perspective view of the telecommunication equipment chassis shown in FIG. 1.

FIG. 3 is a front perspective view of an exemplary embodiment of a tray constructed in accordance with the present disclosure.

FIG. 4 is side elevation view of an exemplary embodiment of a side panel constructed in accordance with the present disclosure.

FIG. 5 is a front perspective view of another exemplary embodiment of a telecommunication equipment chassis constructed in accordance with the present disclosure.

FIG. 6 is a front perspective exploded view of the telecommunication equipment chassis shown in FIG. 5.

FIG. 7 is a front elevation view of an exemplary embodiment of a telecommunication tray assembly constructed in accordance with the present disclosure.

FIG. 8 is a perspective view of an exemplary embodiment of a first type of optical module for use with the telecommunication tray assembly shown in FIG. 7.

FIG. 9 is a perspective view of an exemplary embodiment of a second type of optical module for use with the telecommunication tray assembly shown in FIG. 7.

FIG. 10 is a top plan diagrammatic view of the first type of optical module shown in FIG. 8 and the second type of optical module shown in FIG. 9 installed within the telecommunication tray assembly shown in FIG. 7.

FIG. 11 is a front perspective partial view of the telecommunication tray assembly shown in FIG. 7.

FIG. 12 is a top plan partial view of the telecommunication tray assembly shown in FIG. 7.

FIG. 13 is a front perspective view of an exemplary embodiment of an airflow guide for use with the telecommunication tray assembly shown in FIG. 7.

FIG. 14 is a front elevation view of the airflow guide shown in FIG. 13.

FIG. 15 is a perspective view of the airflow guide shown in FIG. 13 positioned within a bay defined by a base structure and a second frontal section of an exemplary embodiment of a faceplate assembly constructed in accordance with the present disclosure.

FIG. 16 is a partial, magnified cross-sectional view of the airflow guide shown in FIG. 13 positioned within the bay defined by the base structure and the second frontal section of the faceplate assembly shown in FIG. 15, taken along the line 16-16′ and in the direction of the arrows.

FIG. 17 is a process flow diagrammatic view of a method of using the telecommunication tray assembly shown in FIG. 7.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Referring now to the drawings, and in particular to FIG. 1, shown therein is an exemplary embodiment of a telecommunication assembly 10 constructed in accordance with the present disclosure. In general, the telecommunication assembly 10 is provided with a telecommunication equipment chassis 12, one or more piece of telecommunication equipment 14 (hereinafter, the “telecommunication equipment 14”), and one or more fan unit 16 (hereinafter, the “fan unit 16”). The telecommunication equipment chassis 12 may be designed for mounting within a telecommunication rack (not shown) and may be adjustable to permit venting within the telecommunication equipment chassis 12 to occur from a front-to-rear arrangement, a side-to-side arrangement, or a combination of front- and side-to-rear arrangement and preferably without changing a width of the telecommunication equipment chassis 12.

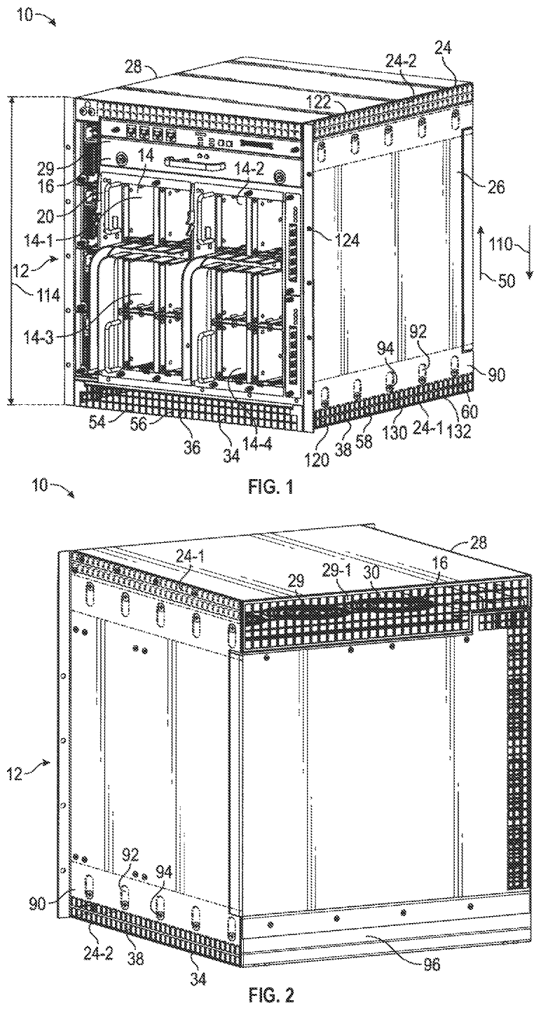

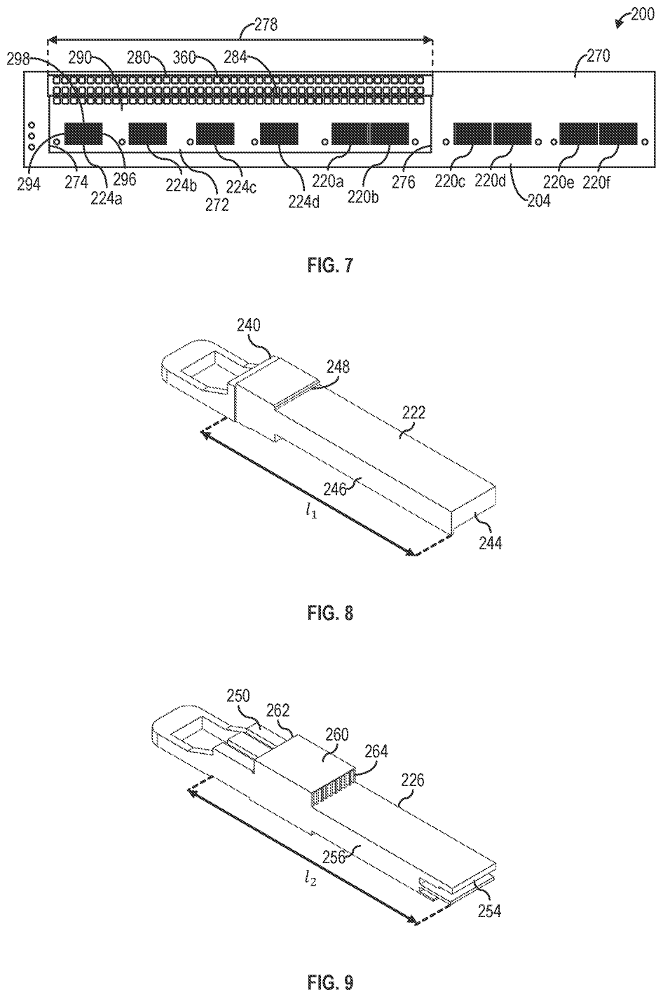

As will be described in more detail below, the telecommunication equipment chassis 12 surrounds and encompasses an equipment bay 20 that is sized and adapted to receive the telecommunication equipment 14 and the fan unit 16. In the example shown in FIG. 1, four pieces of the telecommunication equipment 14 are disposed within the equipment bay 20, including a first piece of telecommunication equipment 14-1, a second piece of telecommunication equipment 14-2, a third piece of telecommunication equipment 14-3, and a fourth piece of telecommunication equipment 14-4. It should be understood that the telecommunication equipment 14 can be in various forms. For example, the telecommunication equipment 14 can be in the form of a telecommunication tray assembly 200 shown and described in FIGS. 7-17 below. In the example shown in FIG. 1, the telecommunication equipment 14 includes optical switches, but other types of telecommunication equipment, such as line cards, computer servers, telecommunication tray assemblies, combinations thereof, and/or the like can be positioned in the equipment bay 20. One skilled in the art would recognize that more or less than four pieces of the telecommunication equipment 14 can be positioned within the equipment bay 20. As discussed above, the fan unit 16 is also disposed within the equipment bay 20, generally near an upper end of the telecommunication equipment chassis 12. In the example shown in FIGS. 1 and 2, only one fan unit 16 is positioned within the equipment bay 20. As will be discussed in more detail below, the fan unit 16 is positioned within the equipment bay 20, draws air into the telecommunication equipment chassis 12 from outside of the telecommunication equipment chassis 12 through openings formed within the telecommunication equipment chassis 12 and through the telecommunication equipment 14, and ejects the air outside of the telecommunication equipment chassis 12.

The telecommunication equipment chassis 12 is provided with one or more tray 24 (hereinafter, the “trays 24”), a first side panel 26, and a second side panel 28. The fan unit 16 may be secured to at least one of the first side panel 26 and the second side panel 28. The fan unit 16 is provided with an enclosure 29 and a fan 30 (shown in FIG. 2) within the enclosure 29. The enclosure 29 has an inlet (not shown) and an outlet 29-1. The fan 30 is configured to move air from the inlet to the outlet 29-1. The inlet is positioned within the equipment bay 20 and in communication with at least one air channel of the telecommunication equipment 14.

In the example shown, the telecommunication equipment chassis 12 is provided with two of the trays 24 with one of the trays 24 forming a bottom of the telecommunication equipment chassis 12 (hereinafter, the “first tray 24-1”), and another one of the trays 24 forming a top of the telecommunication equipment chassis 12 (hereinafter, the “second tray 24-2”). The first side panel 26 is adjustably connected to the first tray 24-1 and the second tray 24-2 so as to permit vertical adjustment of the first tray 24-1 and the second tray 24-2 relative to the first side panel 26. The second side panel 28 is adjustably connected to the first tray 24-1 and the second tray 24-2 to permit vertical adjustment of the first tray 24-1 and the second tray 24-2 relative to the second side panel 28. The vertical adjustment of the first tray 24-1 and/or the second tray 24-2 relative to the first side panel 26 and the second side panel 28 permits modification of venting zones in the front and/or sides of the telecommunication equipment chassis 12. Thus, the size and/or arrangement of the venting zone(s) may be at least partially a function of a relative location of the first side panel 26 and the second side panel 28 relative to the first tray 24-1 and the second tray 24-2. The trays 24, the first side panel 26, and the second side panel 28 can be constructed of any suitable material, such as cold rolled steel, plastic, aluminum, or stainless steel. The material forming the trays 24, the first side panel 26, and the second side panel may have a thickness between 0.05 inches and 0.06 inches, but other thicknesses of material can be used.

In general, the first tray 24-1 and the second tray 24-2 may be substantially similar in construction and function except that the second tray 24-2 may not have a rear wall (such as rear wall 96 shown in FIGS. 2, 3, and 6 and described below) in those instances where the fan unit 16 is adjacent to the second tray 24-2. In such instances, the second tray 24-2 is devoid of a rear wall that would otherwise prevent air from ejecting at the top rear of the telecommunication equipment chassis 12. In such instances, a venting plate (such as the second venting plate 140-2 shown in FIG. 6 and described below) may be used to fill the void left by the absence of a rear wall. For purposes of brevity, only a detailed description with respect to the first tray 24-1 will be discussed herein. However, it should be understood that the discussion with respect to the first tray 24-1 is equally applicable to the second tray 24-2 except for the instance noted above.

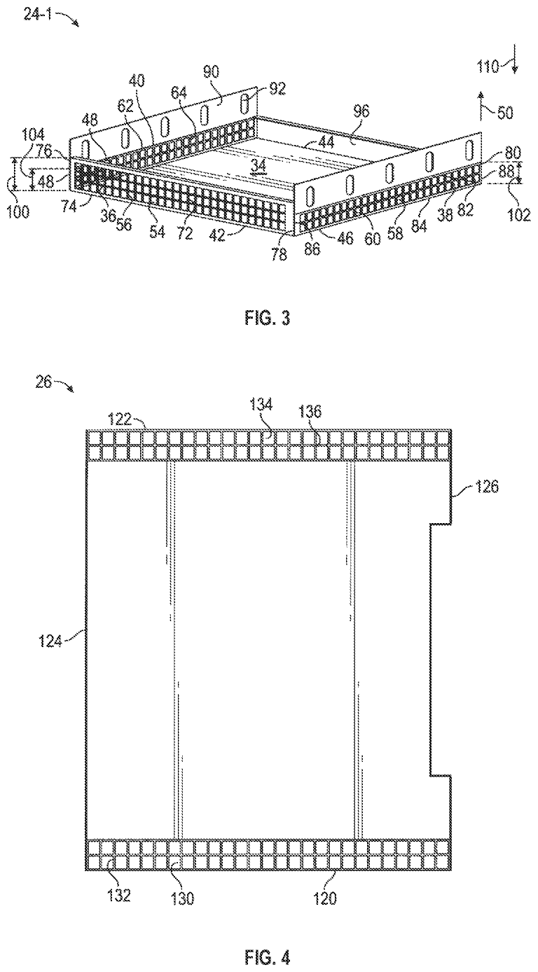

Referring to FIGS. 1 and 3, the first tray 24-1 forms the bottom of the telecommunication equipment chassis 12. The first tray 24-1 is provided with an end wall 34, a front wall 36, a first side wall 38, and a second side wall 40. The end wall 34 has a first end 42, a second end 44, a first side 46, and a second side 48. Preferably, the end wall 34 is constructed of a continuous material that is substantially devoid of any openings intended to provide a vent into the equipment bay 20, but may include one or more opening (not shown) intended for other purposes, including the receipt of a screw for connecting the end wall 34 to another device. The front wall 36 may have a height that is a multiple of a rack unit (i.e., 1.75 inches). In the example shown, the front wall 36 has a height of 1.75 inches. In some embodiments, the first side wall 38 and the second side wall 40 may have a height of at least two rack units (i.e., 3.50 inches).

The front wall 36 may be connected to and extend from the first end 42 of the end wall 34 in a first direction 50 (which in this example is in an upward direction) generally perpendicular to the end wall 34. The first side wall 38 of the first tray 24-1 may be connected to and extend from the first side 46 of the end wall 34 in the first direction 50 generally perpendicular to the end wall 34. The second side wall 40 may be connected to and extend from the second side 48 of the end wall 34 in the first direction 50 generally perpendicular to the end wall 34.

The front wall 36 may have a plurality of first openings 54 which cooperate to define a first venting zone 56. The first side wall 38 may have a plurality of second openings 58 which cooperate to define a second venting zone 60. The second side wall 40 may have a plurality of third openings 62 which cooperate to define a third venting zone 64. The first openings 54, the second openings 58, and the third openings 62 of the first venting zone 56, the second venting zone 60, and the third venting zone 64, respectively, are sized and adapted to permit air to be drawn into the equipment bay 20 of the telecommunication equipment chassis 12 for cooling the telecommunication equipment 14.

The front wall 36 has a perimeter 70 surrounding an area 72. As shown in FIG. 3, the first openings 54 are arranged within a pattern within the first venting zone 56 so that the pattern spans at least 90% of the area 72. The pattern which is depicted within the figures is a grid-like pattern having three rows of polygonally shaped openings; however, it should be understood that other patterns can be used. For example, the first openings 54 can be arranged in a non-grid-like pattern such as a fanciful pattern or a random pattern as desired by the designer of the first tray 24-1.

The front wall 36 has an outer edge 74 which is positioned adjacent to the end wall 34. The first openings 54 can be arranged within the pattern within the first venting zone 56 adjacent to the outer edge 74. The front wall 36 also has a first side 76 and a second side 78 which is opposite from the first side 76. The first openings 54 can be arranged within the pattern such that the first openings 54 extend from the first side 76 to the second side 78, as shown in FIGS. 1 and 3.

The first side wall 38 and the second side wall 40 of the first tray 24-1 may be substantially identical in construction and function. For purposes of brevity, only the first side wall 38 of the first tray 24-1 will be discussed hereinafter. However, it should be understood that such description is equally applicable to the second side wall 40 of the first tray 24-1.

The first side wall 38 of the first tray 24-1 has a perimeter 80 surrounding an area 82. The second openings 58 may be arranged within a pattern within the second venting zone 60 so that the pattern spans at least 90% of the area 82. The first side wall 38 may also have an outer edge 84 positioned adjacent to the end wall 34. The second openings 58 may be arranged within a pattern within the second venting zone 60 adjacent to the outer edge 84. The first side wall 38 may also have a first side 86 and a second side 88 generally opposite to the first side 86. The second openings 58 may be arranged within a pattern extending from the first side 86 to the second side 88, as shown in FIGS. 1 and 3. The pattern which is depicted within the figures is a grid-like pattern having two rows of polygonally shaped openings; however, it should be understood that other patterns can be used. For example, the second openings 58 can be arranged in a non-grid-like pattern such as a fanciful pattern or a random pattern as desired by the designer of the first tray 24-1.

The first side wall 38 may also be provided with a blocking zone 90 having a substantially continuous material so as to prevent the movement of air through the blocking zone 90. The blocking zone 90 is shown in phantom within FIGS. 1 and 2. The blocking zone 90 may extend from the second venting zone 60 in the first direction 50 as shown in FIG. 3. In some embodiments, the blocking zone 90 may have a height of 1.75 inches. In some embodiments, the first side wall 38 may also be provided with a plurality of slots 92 extending vertically to permit adjustment of the first side panel 26 relative to the first tray 24-1. However, other manners of providing vertical adjustment can be used, such as a series of vertically positioned screw holes, or a separate mechanism, such as a rack and pinion assembly. The plurality of slots 92 are shown in phantom in FIGS. 1, 2, and 5. Each of the slots 92 is sized and configured to receive a screw 94 for adjustably connecting the first side panel 26 to the first side wall 38 as shown in FIG. 1. In the example depicted in FIGS. 1 and 3, the first side wall 38 is provided with five of the slots 92; however, more or less of the slots 92 can be used so long as the slots 92 are sufficient in size and dimension to permit adjustment of a vertical position of the screws 94 within the slots 92 while also maintaining sufficient strength to secure the first side panel 26 to the first side wall 38. In some embodiments, the slots 92 have a length, which is a multiple of a rack unit (i.e., 1.75 inches). For example, in the example shown, the slots 92 have a length of 1.75 inches (i.e., one rack unit).

The first tray 24-1 may also be provided with a rear wall 96 extending from the second end 44 of the end wall 34 in the first direction 50 and generally perpendicular to the end wall 34. Preferably, the rear wall 96 is substantially devoid of any openings intended to provide a vent into the equipment bay 20 of the telecommunication equipment chassis 12 so that air is directed into the first openings 54, the second openings 58, and the third openings 62 of the first venting zone 56, the second venting zone 60, and the third venting zone 64, respectively.

As shown in FIG. 1, the first venting zone 56 is provided on a front of the telecommunication equipment chassis 12 while the second venting zone 60 and the third venting zone 64 are provided on the side of the telecommunication equipment chassis 12. In this configuration, the first openings 54, the second openings 58, and the third openings 62 of the first venting zone 56, the second venting zone 60, and the third venting zone 64, respectively, are unobstructed such that air is drawn by the fan unit 16 through the first openings 54, the second openings 58, and the third openings 62, and through the pieces of telecommunication equipment 14. The first venting zone 56 is provided with a first height 100, the second venting zone 60 is provided with a second height 102, and the third venting zone 64 is provided with a third height 104.

When the first tray 24-1 is configured to provide an adjustment of one rack unit, in some embodiments, the first height 100 may be 1.5 inches, the second height 102 may be in a range from 1.0-1.5 inches, and the third height 104 may be in a range from 1.0-1.5 inches. In the example shown, the first height 100 is greater than the second height 102 and the third height 104 so as to establish a greater amount of airflow through the first venting zone 56 relative to the second venting zone 60 and the third venting zone 64. However, it should be understood that in other embodiments the first height 100 may be the same as or even less than the second height 102 and the third height 104, depending upon where the designer would prefer to permit the greater amount of airflow.

The first side panel 26 and the second side panel 28 may be substantially identical in construction and function. For purposes of brevity, only the first side panel 26 of the first tray 24-1 will be discussed hereinafter. However, it should be understood that such description is equally applicable to the second side panel 28.

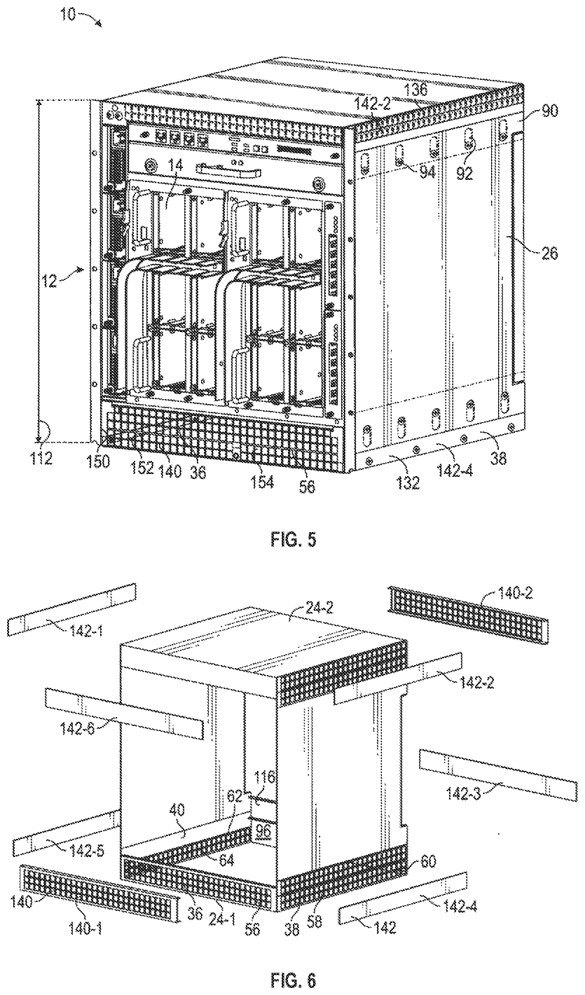

The first side panel 26 is shown in FIGS. 1, 2, and 4. As discussed above, the first side panel 26 is adjustably connected to the first side wall 38 to permit movement in the first direction 50 and a second direction 110 which changes the manner in which there is vented through the telecommunication equipment chassis 12. In particular, the first side panel 26 is movable between a first position which is shown in FIG. 5 and a second position which is shown in FIG. 1. The telecommunication equipment chassis 12 has a height 112 in the first position, and a height 114 in the second position. In the example shown, the height 112 when the first side panel 26 is in the first position is greater than the height 114 when the first side panel 26 is in the second position.

The first side panel 26 has a first end 120, a second end 122, a first side 124 (that is adjacent to a front of the telecommunication equipment chassis 12) and a second side 126 (that is adjacent to a rear of the telecommunication equipment chassis 12). The first end 120 is adjacent to a bottom of the telecommunication equipment chassis 12, and the second end 122 is adjacent to a top of the telecommunication equipment chassis 12. The first side panel 26 is also provided with a plurality of first openings 130 that are positioned adjacent to the first end 120 and define a first side venting zone 132, and a plurality of second openings 134 that are positioned adjacent to the second end 122 and define a second side venting zone 136. As shown in FIG. 1, the first side venting zone 132 of the first side panel 26 overlaps the second venting zone 60 such that the second openings 58 in the first side wall 38 and the first openings 130 in the first side panel 26 are aligned to permit air to flow into the equipment bay 20.

Outside of the first side venting zone 132 and the second side venting zone 136, the first side panel 26 may be constructed of a substantially continuous material which is devoid of any openings intended to provide a vent into the equipment bay. However, it should be understood that the first side panel 26 can be provided with a variety of openings utilized to receive screws for connecting the first side panel 26 to the first tray 24-1 and/or the second tray 24-2 as well as connecting the first side panel 26 to the telecommunication equipment 14, the fan unit 16, and/or other devices.

When the first side panel 26 is in the first position and the height 112 is greater than the height 114, as shown in FIG. 5, the telecommunication equipment chassis 12 may be configured for solely front-to-rear venting, meaning that air is drawn into the equipment bay 20 from a front of the telecommunication equipment chassis 12 and ejected out a rear of the telecommunication equipment chassis 12. In the first position, it may be desirable to prevent any airflow from passing through the first side wall 38 and the second side wall 40 of the first tray 24-1, as well as to supplement the airflow that is provided through the front wall 36 of the first tray 24-1.

To direct the airflow for a solely front to rear venting arrangement, the telecommunication equipment chassis 12 may be provided with one or more venting plate 140 (hereinafter, the “venting plates 140”) and/or one or more blocking plate 142 (hereinafter, the “blocking plates 142”) as shown in FIGS. 5 and 6. In the example depicted in FIG. 6, the telecommunication equipment chassis 12 may be provided with two of the venting plates 140, such as a first venting plate 140-1 and a second venting plate 140-2. The telecommunication equipment chassis 12 may also be provided with six of the blocking plates 142, such as a first blocking plate 142-1, a second blocking plate 142-2, a third blocking plate 142-3, a fourth blocking plate 142-4, a fifth blocking plate 142-5, and a sixth blocking plate 142-6.

A particular one of the venting plates 140 is shown in FIG. 5. The particular one of the venting plates 140 has a perimeter 150 surrounding an area 152. The particular one of the venting plates 140 is also provided with a plurality of openings 154 that are arranged within a pattern within the perimeter 150 so that the pattern and the openings 154 span at least 90% of the area 152. The pattern, which is depicted within FIG. 5, is a grid-like pattern having three rows of polygonally shaped openings; however, it should be understood that other patterns can be used. For example, the openings 154 can be arranged in a non-grid-like pattern such as a fanciful pattern or a random pattern as desired by the designer of the particular one of the venting plates 140. In the example shown, the particular one of the venting plates 140 is positioned adjacent to the front wall 36 so as to provide a substantially continuous venting zone formed by combination of the particular one of the venting plates 140 and the front wall 36. In one embodiment, the particular one of the venting plates 140 can be positioned so as to overlap a portion of the front wall 36 is depicted within FIG. 5. However, it should be understood that other configurations are possible, such as the front wall 36 overlapping a portion of the particular one of the venting plates 140.

Some of the blocking plates 142 are depicted in FIG. 5, namely the second blocking plate 142-2 and the fourth blocking plate 142-4. In general, the blocking plates 142 may be provided with a substantially continuous material that is devoid of any openings which are intended to be used for a venting purpose. The blocking plates 142 may, however, be provided with various openings and/or apertures for receiving a screw for connecting the blocking plates 142 to portions of the telecommunication equipment chassis 12, such as the first side panel 26 is depicted in FIG. 5. One of the blocking plates 142, such as the fourth blocking plate 142-4 (shown in FIGS. 5 and 6), may be positioned over the first side wall 38 so as to block any airflow which may occur through the second openings 58, and another one of the blocking plates 142, such as the fifth blocking plate 142-5 (shown in FIG. 6), may be positioned over the second side wall 40 to block any airflow which may occur through the third openings 62.

As shown in FIG. 6, the first blocking plate 142-1 may be positioned over a third venting zone of a second side wall of the second tray 24-2 to prevent side venting. The second blocking plate 142-2 may be positioned over a second venting zone of a first side wall of the second tray 24-2 to prevent side venting. The third blocking plate 142-3 may be positioned over an open space 116 adjacent to the rear wall 96 (also shown in FIG. 2) to prevent air from entering the bottom rear of the telecommunication equipment chassis 12. The fourth blocking plate 142-4 may be positioned over the second venting zone 60 of the first side wall 38 and the first tray 24-1 to prevent side venting. The fifth blocking plate 142-5 may be positioned over the third venting zone 64 of the second side wall 40 of the first tray 24-1 to prevent side venting; and the sixth blocking plate 142-6 may be positioned over a first venting zone of a front wall of the second tray 24-2 to prevent air from entering or exiting the telecommunication equipment chassis 12 at the top of the same. The first venting plate 140-1 may be positioned adjacent to and overlapping with the first venting zone 56 of the front wall 36 of the first tray 24-1 to allow air to be drawn in the bottom front of the telecommunication equipment chassis 12; and the second venting plate 140-2 may be positioned over a rear wall of the second tray 24-2 to allow air to exit through the top rear of the telecommunication equipment chassis 12 and to fill a void that would otherwise be left by the absence of a rear wall on the second tray 24-2.

If the user desires front-to-rear venting only, then the configuration of the telecommunication equipment chassis 12, the venting plates 140, and the blocking plates 142 as shown in FIGS. 5 and 6 (and described immediately above) may be deployed. This way, air may be drawn in the bottom front of the telecommunication equipment chassis 12, through the telecommunication equipment 14, and exit the top rear of the telecommunication equipment chassis 12. If the user desires side-to-side venting, then a modification of the configuration of the telecommunication equipment chassis 12 as shown in FIGS. 1 and 2 may be deployed by adding and positioning a blocking plate (not shown) over the first venting zone 56 of the front wall 36 of the first tray 24-1. This way, air will be drawn in the bottom sides of the telecommunication equipment chassis 12 and through the telecommunication equipment 14 and exit the top rear of the telecommunication equipment chassis 12. If the user desires a combination of front- and side-to-rear venting, then the configuration of the telecommunication equipment chassis 12 as shown in FIGS. 1 and 2 may be deployed. This way, air may be drawn in the bottom front and bottom sides of the telecommunication equipment chassis 12, through the telecommunication equipment 14, and exit the top rear of the telecommunication equipment chassis 12. These various venting systems may be achieved by modifying the height of the telecommunication equipment chassis 12 (along with applying various combinations of the venting plates 140 and the blocking plates 142) and without modifying the width of the telecommunication equipment chassis 12.

FIGS. 7 and 10-12 depict a telecommunication tray assembly 200 constructed in accordance with the present disclosure. The telecommunication tray assembly 200 is configured to be positioned within the equipment bay 20 described above. As discussed above, the fan unit 16 is also disposed within the equipment bay 20. In the example shown in FIGS. 1 and 2, only one fan unit 16 is positioned within the equipment bay 20 near an upper end of the telecommunication equipment chassis 12. As will be discussed in more detail below, the fan unit 16 positioned within the equipment bay 20, draws air into the telecommunication equipment chassis 12 from outside of the telecommunication equipment chassis 12 through openings formed within the telecommunication equipment chassis 12 and through the telecommunication tray assembly 200 to cool the telecommunication equipment 14, and ejects the air outside of the telecommunication equipment chassis 12.

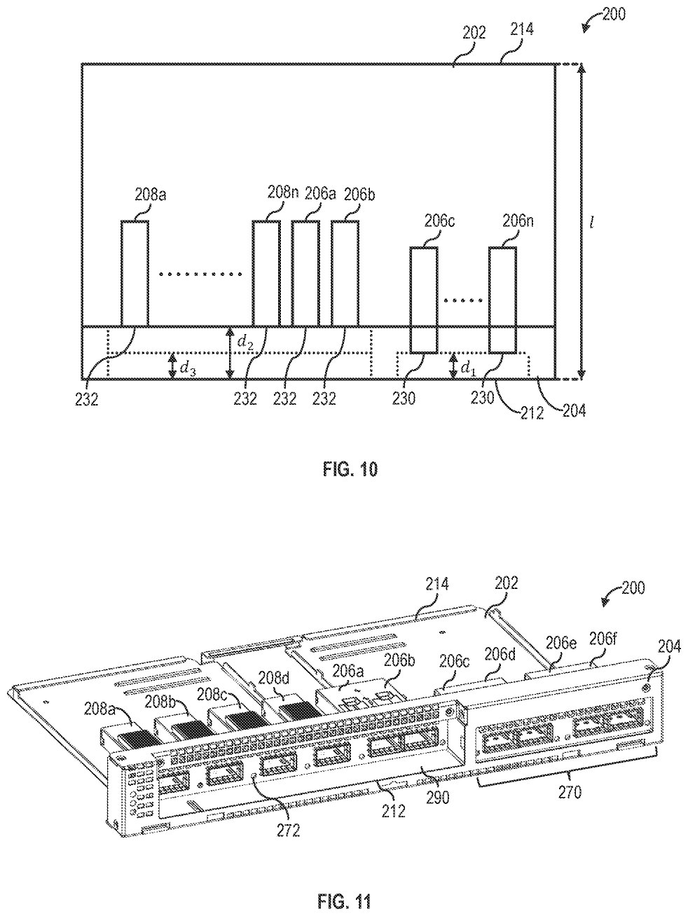

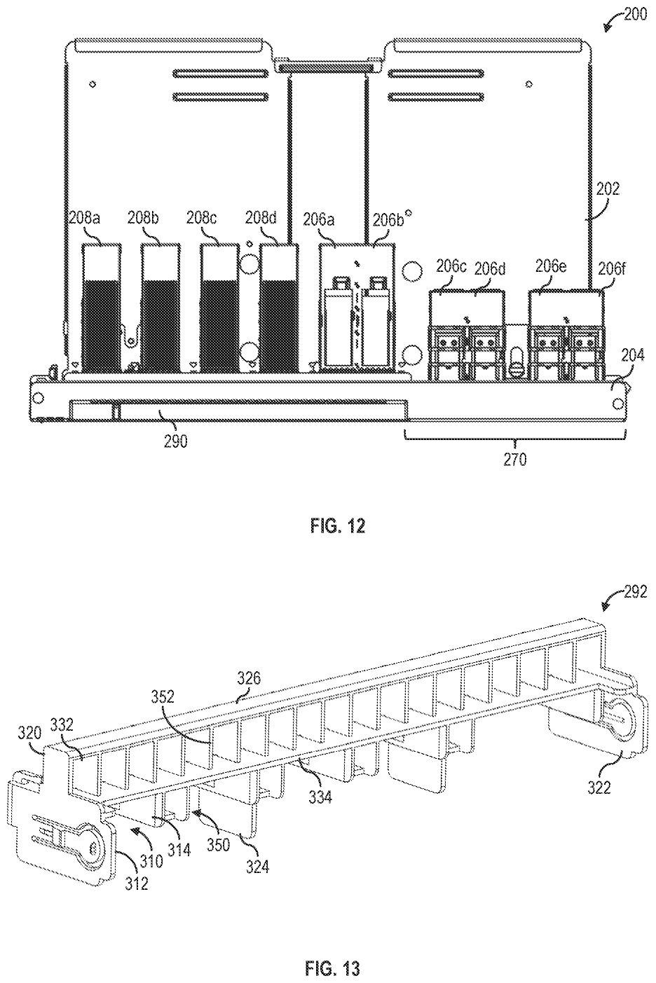

The telecommunication tray assembly 200 is provided with a base structure 202, a faceplate assembly 204, one or more first port 206 (hereinafter, the “first ports 206”), and one or more second port 208 (hereinafter, the “second ports 208”). In the example shown, the telecommunication tray assembly 200 is provided with six of the first ports 206 labeled in FIG. 12 as 206a, 206b, 206c, 206d, 206e, and 206f. As shown in the diagrammatic view of FIG. 10, more or less of the first ports 206 can be provided in the telecommunication tray assembly 200. This is why the first ports are labeled 206a, 206b, 206c and 206n in FIG. 10. Similarly, in the example shown in FIG. 12, the telecommunication tray assembly 200 is provided with four of the second ports 208a, 208b, 208c and 208d. As shown in the diagrammatic view of FIG. 10, more or less of the second ports 208 can be provided in the telecommunication tray assembly 200. This is why the second ports 208 are labeled 208a and 208n in FIG. 10.

The base structure 202 has a front end 212, a rear end 214, and a length l extending from the front end 212 to the rear end 214. The faceplate assembly 204 may be attached to the front end 212 of the base structure 202. The faceplate assembly 204 extends vertically upward from the base structure 202 as shown for example in FIG. 11. The faceplate assembly 204 defines one or more first opening 220 (hereinafter, the “first openings 220”) configured to receive a first type of optical module 222 (see FIG. 8) and one or more second opening 224 (hereinafter, the “second openings 224”) configured to receive a second type of optical module 226 (see FIG. 9). In the example shown in FIG. 7, the faceplate assembly 204 defines six of the first openings 220, and the first openings 220 are labeled as 220a-f in FIG. 7. Similarly, in the example shown in FIG. 7, the faceplate assembly 204 defines four of the second openings 224, and the second openings 224 are labeled as 224a-d in FIG. 7.

In some embodiments, the first type of optical module 222 is known in the art as a Quad Small Form-factor Pluggable (QSFP) optical module. A QSFP optical module is a high-speed transceiver commonly used in data communication applications, particularly in data centers and high-performance computing environments. QSFP modules support various optical and electrical interfaces, enabling efficient transmission of data over short or long distances. The components of a QSFP optical module typically include optical transmitters and receivers, fiber optic interfaces, integrated circuits, microcontroller and EEPROM, optical sub-assemblies, thermal management components, and control and monitoring interfaces. The optical transmitters and receivers are configured to transmit and receive data signals over fiber optic cables. These components convert electrical signals into optical signals for transmission and vice versa. The fiber optic interfaces may be LC or MPO/MTP connectors, depending on the module type. These fiber optic interfaces allow the QSFP optical module to connect to optical fibers for data transmission. The various integrated circuits, include driver and receiver ICs, which manage the transmission and reception of data signals. These ICs control the operation of the QSFP module and optimize signal integrity. QSFP modules often include a microcontroller and an Electrically Erasable Programmable Read-Only Memory (EEPROM) chip. The microcontroller manages the functionality of the module, while the EEPROM stores essential information such as module type, serial number, vendor information, and configuration data. QSFP modules also include optical subassemblies, including laser diodes, photodiodes, lenses, and other optical components, which generate and detect optical signals with high precision and efficiency. Due to the high-speed operation and power consumption of QSFP modules, the QSFP modules often incorporate thermal management components such as heat sinks, thermal pads, or fans to dissipate heat and maintain optimal operating temperatures. QSFP modules may also feature control and monitoring interfaces, such as the I2C (Inter-Integrated Circuit) interface, which allows for real-time monitoring of module parameters such as temperature, voltage, and optical power levels. The components of the QSFP modules work together to enable high-speed, reliable data transmission over optical fiber networks.

In some embodiments, the second type of optical module 226 may be a QSFP-DD (Quad Small Form-factor Pluggable Double Density) optical module. The QSFP-DD optical module is an advanced form of the QSFP transceiver that offers increased port density and higher data rates. QSFP-DD optical modules support various optical and electrical interfaces, enabling efficient transmission of data in high-performance computing environments, data centers, and telecommunications networks.

The first ports 206 are supported by the base structure 202 and are each aligned with a respective one of the first openings 220. The first ports 206 are configured to receive the first type of optical module 222 through the first openings 220. At least some of the first ports 206 have a first leading edge 230 (see FIG. 10) offset from the front end 212 by a first distance d₁.

The second ports 208 are supported by the base structure 202 and are each aligned with a respective one of the second openings 224. The second ports 208 are configured to receive the second type of optical module 226. The second ports 208 have a second leading edge 232 offset from the front end 212 by a second distance d₂ larger than the first distance d₁. In some embodiments, the second distance d₂ is larger than the first distance d₁ by 20 mm to accommodate differences in dimensions between the first type of optical module 222 (e.g., QSFP modules) and the second type of optical module 226 (e.g., QSFP-DD modules).

Referring to FIG. 8, shown therein is a perspective view of the first type of optical module 222 for use with the telecommunication tray assembly 200 in accordance with the present disclosure. The first type of optical module 222 is provided with a head end 240 having two optical ports 242a and 242b (see FIG. 15). The two optical ports 242a and 242b have only been labeled on one of the first type of optical module 222 in FIG. 15 for purposes of clarity. The first type of optical module 222 is also provided with a tail end 244 generally opposite from the head end 240. The tail end 244 can be configured with electrical connectors designed to mate with complementary electrical connectors positioned within the first port 206. The first type of optical module 222 is also provided with a housing 246 extending from the head end 240 to the tail end 244. The housing 246 is provided with an outwardly extending shoulder 248 positioned adjacent to the head end 240. The shoulder 248 may be designed to mate against the faceplate assembly 204. The first type of optical module 222 is also provided with a length l₁ extending from the head end 240 to the tail end 244.

FIG. 9 is a perspective view of the second type of optical module 226 for use with the telecommunication tray assembly 200 in accordance with the present disclosure. The second type of optical module 226 is provided with a head end 250 having two optical ports 252a and 252b (see FIG. 15). The two optical ports 252a and 252b have only been labeled on one of the second type of optical module 226 in FIG. 15 for purposes of clarity. The second type of optical module 226 is also provided with a tail end 254 generally opposite from the head end 250. The second type of optical module 226 is also provided with a length l₂ extending from the head end 250 to the tail end 254. The tail end 254 can be configured with electrical connectors designed to mate with complementary electrical connectors positioned with the second port 208. The second type of optical module 226 is also provided with a housing 256 extending from the head end 250 to the tail end 254. The housing 256 is provided with an outwardly extending shoulder 258 positioned adjacent to the head end 240. The shoulder 258 may be designed to mate against the faceplate assembly 204.

As the skilled artisan would understand, the QSFP-DD is constructed in a similar manner as the QSFP module, but has a larger length, and also includes a Transmit-Receive Optical Sub-Assembly (TROSA) 260 positioned near the head end 250 and between the head end 250 and the tail end 254. The TROSA 260 has a first end 262, a second end 264 opposite the first end, and a heat sink disposed between the first end 262 and the second end 264 that will be described in more detail below. In some embodiments, the second distance d₂ (see FIG. 10) is larger than the first distance d₁ by 20 mm to accommodate differences in dimensions between the first type of optical module 222 (e.g., a QSFP module) and the second type of optical module 226 (e.g., a QSFP-DD module).

Referring again to FIGS. 7, 11, and 12, the faceplate assembly 204 will be described in more detail. In general, the base structure 202 is configured to support the first ports 206 and the second ports 208 such that the second ports 208 are offset farther from the front end 212 to accommodate differences in dimensions between the first type of optical module 222 (e.g., a QSFP module) and the second type of optical module 226 (e.g., a QSFP-DD module) while aligning the head ends 240 and the head ends 250 to be in a plane that is substantially parallel to the front end 212 as shown in FIG. 15. By recessing the second ports 208 relative to the first ports 206, enhanced space outside of the faceplate assembly 204 can be achieved, thereby facilitating the routing of fiber optic cables connected to the first type of optical module 222 and the second type of optical module 226.

As shown in FIGS. 11 and 12, the faceplate assembly 204 has a first frontal section 270 aligned with the front end 212 of the base structure 202. The first frontal section 270 defines the first openings 220. The faceplate assembly 204 also includes a second frontal section 272 offset from the front end 212 of the base structure 202 a third distance (e.g., the distance d₂ described above) greater than the first distance d₁. The second frontal section 272 defines the second openings 224 (labeled in FIG. 7 with the reference numerals 224a, 224b, 224c and 224d). As shown in FIGS. 7 and 11, the second frontal section 272 has a first side 274, a second side 276, and a width 278 extending from the first side 274 to the second side 276. The faceplate assembly 204 may also have a third frontal section 280 contiguous along the width 278 of the second frontal section 272. The third frontal section 280 may be parallel to the front end 212 and offset from the front end 212 a fourth distance d₃ between the first distance d₁ and the third distance d₂. In some embodiments, the fourth distance d₃ is 10 mm, although this distance may vary.

Referring in particular to FIG. 7, the second frontal section 272 has a plurality of first airflow openings 284 adjacent to the second port 208. The first airflow openings 284 may be configured in one or more row extending generally across the width 278 of the second frontal section 272.

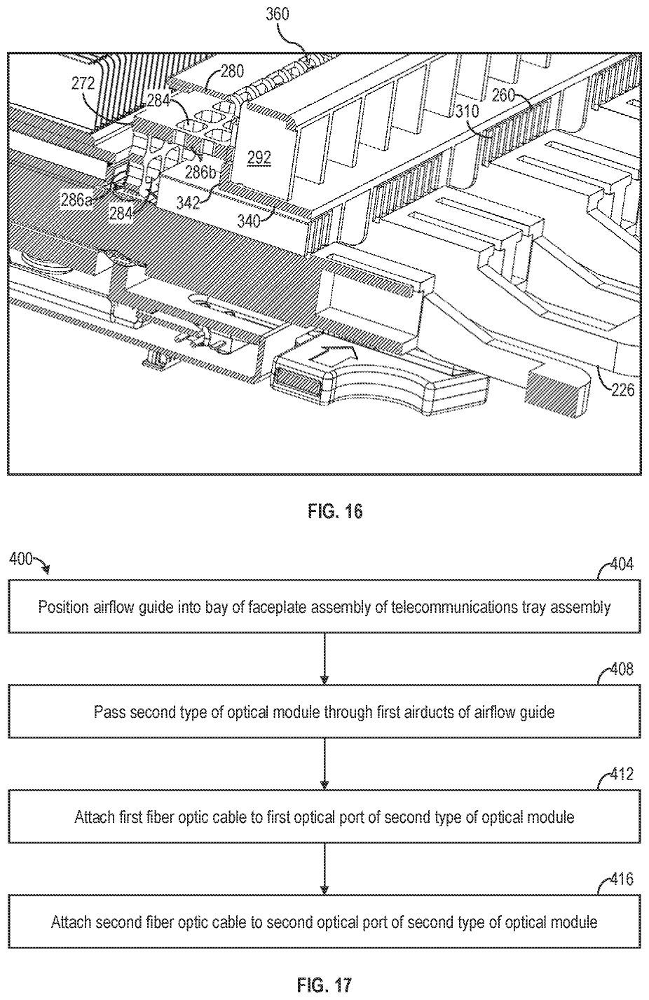

As best shown in FIG. 16, the second frontal section 272 can be an L-shaped structure having a vertical wall 286a extending upwardly from the base structure 202, and a horizontal wall 286b extending horizontally from the vertical wall 286a to the third frontal section 280. The second frontal section 272 may be joined with the third frontal section 280 to form a continuous structure. The second frontal section 272 and the third frontal section 280 can be made, in some embodiments, from a unitary piece of sheet metal that has been formed into the configuration shown in the drawings, for example. The first airflow openings 284 can be arranged in rows provided in the vertical wall 286a and the horizontal wall 286b. The fan unit 16 positioned within the equipment bay 20 draws air into the telecommunication equipment chassis 12 from outside of the telecommunication equipment chassis 12 through openings formed within the telecommunication equipment chassis 12, and through the first airflow openings 284 to cool telecommunication equipment within the telecommunication tray assembly 200, such as the second type of optical module 226, and ejects the air outside of the telecommunication equipment chassis 12. Because the first airflow openings 284 are adjacent to the TROSA 260 of the second type of optical module 226, the air entering the first airflow openings 284 passes across the TROSA 260, thereby cooling the TROSA 260 of the second type of optical module 226.

Due to the offsets described above with respect to the second frontal section 272 and the third frontal section 280 of the faceplate assembly 204, the base structure 202 and the second frontal section 272 and the third frontal section 280 define a bay 290 which is best shown in FIG. 11. The bay 290 is configured to receive the second type of optical module 226, at least some of the first type of optical module 222, and an airflow guide 292 depicted in FIGS. 13-16. As will be described in detail below, the airflow guide 292 is designed to direct air being drawn into the first airflow openings 284 across the TROSA 260 of the second type of optical module 226, thereby cooling the TROSA 260 of the second type of optical module 226.

In some embodiments, the second openings 224a-d have a rectangular shape having a first edge 294, a second edge 296 and a top edge 298 extending from the first edge 294 to the second edge 296. Each of the second openings 224 may be constructed in a similar manner. The airflow guide 292 may be positioned within the bay 290. When the airflow guide 292 is positioned within the bay 290, the airflow guide 292 has one or more first air duct 310 (hereinafter, the “first air ducts 310”) in fluid communication with the first airflow openings 284. The first air ducts 310 may extend between the first end 262 and the second end 264 of the TROSA 260. In the embodiment of the airflow guide 292 shown in FIG. 13-16, the airflow guide 292 forms multiple adjacent ones of the first air ducts 310 that are similar in construction and function. For purposes of brevity, only one of the first air ducts 310 will be described herein. However, such description is equally applicable to the other(s) of the first air ducts 310. The airflow guide 292 may be secured in the bay 290 with any suitable fastening system, such as screws or rivets, tabs, or the like.

Each of the first air ducts 310 has a first side surface 312, a second side surface 314 and a top surface 316 extending from the first side surface 312 to the second side surface 314. The first side surface 312 is positioned adjacent to the first edge 294, the second side surface 314 is positioned adjacent to the second edge 296, and the top surface 316 is positioned adjacent to the top edge 298. When the second type of optical module 226 is installed in the second port 208, the TROSA 260 is positioned within the first air ducts 310 to direct cooling air across the TROSA 260.

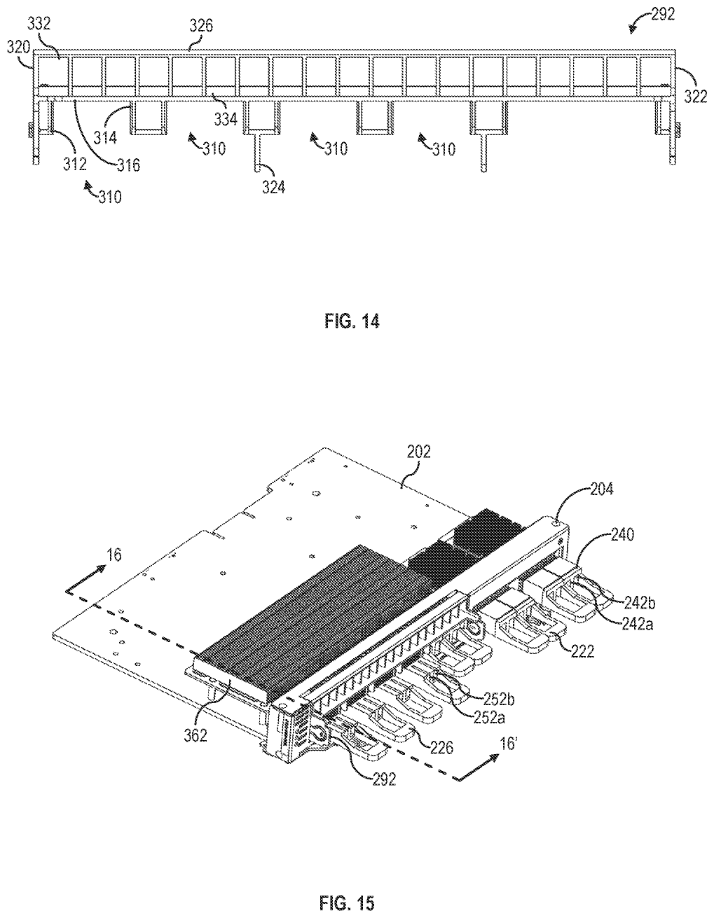

Referring to FIGS. 13 and 14, the airflow guide 292 has a first end 320, a second end 322, a lower end 324, an upper end 326, and a grid structure 330 defining the first air ducts 310 across the lower end 324 and the second air ducts 332 across the upper end 326. For purposes of clarity, only one of the second air ducts 332 is labeled in FIGS. 13 and 14. The grid structure 330 includes a first horizontal member 334 and a second horizontal member 336.

The first horizontal member 334 extends from the first end 320 to the second end 322. The first horizontal member 334 is positioned between the lower end 324 and the upper end 326. The first air ducts 310 are below the first horizontal member 334, and the second air ducts 332 are above the first horizontal member 334. The first horizontal member 334 separates the first air ducts 310 from the second air ducts 332. As shown in FIG. 16, the first horizontal member 334 has an L-shaped cross-section having a horizontal divider 340 and a vertical divider 342. The vertical divider 342 extends upwardly from the horizontal divider 340. When installed in the bay 290, the vertical divider 342 engages the second frontal section 272 to cause air being drawn into the first airflow openings 284 to pass through the first air ducts 310.

The second horizontal member 336 extends from the first end 320 to the second end 322. The second horizontal member 336 is positioned at the upper end 326. The second air ducts 332 are below the second horizontal member 336. The first horizontal member 334 forms a top of the second air ducts 332.

The grid structure 330 also includes a plurality of spaced apart first vertical members 350 extending downwardly from the first horizontal member 334, and a plurality of spaced apart second vertical members 352 extending upwardly from the first horizontal member 334 to the second horizontal member 336. The spaced apart second vertical members 352, an upper surface of the first horizontal member 334 and a lower surface of the second horizontal member 336 defines each of the second air ducts 332.

Referring again to FIG. 7, the third frontal section 280 defines a plurality of second airflow openings 360 extending along the width thereof. The second airflow openings 360 can be arranged in one or more row. As shown in FIG. 7, the second airflow openings 360 are arranged in two rows. The second airflow openings 360 permit the fan unit 16 to draw air through the second airflow openings 360 such that the air passes across a heat sink 362 positioned on the base structure 202 above the second ports 208 and adjacent to the third frontal section 280.

The grid structure 330 of the airflow guide 292 is shaped so as to conform to the outer boundaries of the bay 290 so as to in essence form a seal between the grid structure and the second frontal section 272 and the third frontal section 280 of the faceplate assembly 204. The grid structure 330 guides air into the first airflow openings 284 and the second airflow openings 360 such that air being drawn through the first airflow openings 284 passes across the TROSA 260 as described above.

While the first type of optical module 222 and the second type of optical module 226 are described herein as being installed within the same telecommunication tray assembly 200, it should be understood that various combinations of the first type of optical module 222 and the second type of optical module 226 may be installed within different telecommunication tray assemblies 200 installed within the telecommunication equipment chassis 12.

Referring now to FIG. 17, shown therein is an exemplary method 400 of using the telecommunication tray assembly 200 in accordance with the present disclosure. As shown in FIG. 17, the method 400 generally comprises the steps of: positioning the airflow guide 292 into the bay 290 of the faceplate assembly 204 of the telecommunication tray assembly 200 (step 404); passing one or more of the second type of optical module 226 (e.g., a QSFP-DD) through one or more of the first air ducts 310 of the airflow guide 292, through one or more of the second openings 224, and into one or more of the second ports 208 to mate the electrical connectors of the one or more of the second type of optical module 226 (e.g., a QSFP-DD) with the complementary electrical connectors positioned with the one or more of the second ports 208 (step 408); and attaching one or more first fiber optic cable (not shown) to the first optical port 252a of each of the one or more of the second type of optical module 226 (e.g., a QSFP-DD) (step 412); and attaching one or more second fiber optic cable (not shown) to the second optical port 252b of each of the one or more of the second type of optical module 226 (e.g., a QSFP-DD) (step 416). Further, in some embodiments, the method also includes passing one or more of the first type of optical module 222 (e.g., a QSFP) through one or more of the first openings 220, and into one or more of the first ports 206 to mate the electrical connectors of the one or more of the first ports 206. In some embodiments, the method may further comprise passing one or more of the first type of optical module 222 (e.g., a QSFP) through one or more of the first openings 220, and into one or more of the first ports 206 to mate the electrical connectors of the one or more of the first ports 206 with or without passing the first type of optical module 222 through one or more of the first air ducts 310, respectively, of the airflow guide 292.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A telecommunication tray assembly, comprising:
a base structure having a front end, a rear end opposite the front end, and a length extending from the front end to the rear end;
a faceplate assembly attached to the base structure, the faceplate assembly defining a first opening configured to receive a first type of optical module and a second opening configured to receive a second type of optical module;
a first port supported by the base structure and aligned with the first opening, the first port configured to receive the first type of optical module and having a first leading edge offset from the front end by a first distance; and
a second port supported by the base structure and aligned with the second opening, the second port configured to receive the second type of optical module and having a second leading edge offset from the front end by a second distance larger than the first distance.

2. The telecommunication tray assembly of claim 1, wherein the faceplate assembly has a first frontal section aligned with the front end of the base structure and a second frontal section offset from the front end of the base structure by a third distance greater than the first distance, the first frontal section defining the first opening, the second frontal section defining the second opening.

3. The telecommunication tray assembly of claim 2, wherein the second frontal section has a first side, a second side opposite the first side, and a width extending from the first side to the second side, and wherein the faceplate assembly has a third frontal section contiguous along the width of the second frontal section, the third frontal section being parallel to the front end and offset from the front end by a fourth distance between the first distance and the third distance.

4. The telecommunication tray assembly of claim 2, wherein the second frontal section has a plurality of first airflow openings adjacent to the second opening, wherein the base structure and the second frontal section define a bay, wherein the second opening has a rectangular shape having a first edge, a second edge opposite the first edge, and a top edge extending from the first edge to the second edge, and further comprising an airflow guide positioned within the bay, the airflow guide having a first air duct in fluid communication with the first airflow openings, the first air duct having a first side surface, a second side surface opposite the first side surface, and a top surface extending from the first side surface to the second side surface, the first side surface positioned adjacent to the first edge, the second side surface positioned adjacent to the second edge, and the top surface positioned adjacent to the top edge.

5. The telecommunication tray assembly of claim 4, wherein the second frontal section has a first side, a second side opposite the first side, and a width extending from the first side to the second side, and wherein the faceplate assembly has a third frontal section contiguous along the width of the second frontal section, the third frontal section being parallel to the front end and offset from the front end by a fourth distance between the first distance and the third distance, the third frontal section define a plurality of second airflow openings, and wherein the airflow guide has a second air duct above the first air duct, the second air duct being in fluid communication with the second airflow openings.

6. The telecommunication tray assembly of claim 5, wherein the first air duct is a plurality of first air ducts, the second air duct is a plurality of second air ducts, and the airflow guide has a first end, a second end opposite the first end, a lower end, an upper end opposite the lower end, and a grid structure defining the plurality of first air ducts across the lower end and the plurality of second air ducts across the upper end.

7. The telecommunication tray assembly of claim 5, first comprising a first optical module of the first type of optical module positioned through the first opening of the faceplate assembly and into the first port and a second optical module of the second type of optical module positioned through the second opening of the faceplate assembly and into the second port, the first optical module having a first optical port and the second optical module having a second optical port, the first optical port and the second optical port being outside of a boundary of the faceplate assembly and spaced from the faceplate assembly by a fifth distance.

8. The telecommunication tray assembly of claim 7, wherein the second optical module is a Quad Small Form-factor Pluggable Double Density) optical module having a Transmit-Receive Optical Sub-Assembly positioned within the first air duct.

9. The telecommunication tray assembly of claim 1, further comprising a first optical module of the first type of optical module positioned through the first opening of the faceplate assembly and into the first port and a second optical module of the second type of optical module positioned through the second opening of the faceplate assembly and into the second port, the first optical module having a first optical port and the second optical module having a second optical port, the first optical port and the second optical port being outside of a boundary of the faceplate assembly and spaced a fifth distance from the faceplate assembly.

10. The telecommunication tray assembly of claim 9, wherein the first optical module is a Quad Small Form-factor Pluggable optical module, and the second optical module is a Quad Small Form-factor Pluggable Double Density optical module.
